(19) United States
(12) Patent Application Publication
(10) Pub. No.: US 2021/0288478 A1
(43) Pub. Date: Sep. 16, 2021

(54) J-Hook Device for Untwisting Wire

(71) Applicant: Jeffrey M Wildrick, South Dartmouth, MA (US)

(72) Inventor: Jeffrey M Wildrick, South Dartmouth, MA (US)

(21) Appl. No.: 17/196,041

(22) Filed: Mar. 9, 2021

Related U.S. Application Data
(60) Provisional application No. 62/987,508, filed on Mar. 10, 2020.

(51) Int. Cl. H02G 1/12

(52) U.S. Cl. CPC H02G 1/1292

(57) ABSTRACT

A J-hook device for untwisting wire is provided The device includes a knurled J-hook section; a shaft section connected to the knurled J-hook section; and a shank section connected to the shaft section. The shank section is adaptable to fit within a drill chuck.

### CROSS-REFERENCE TO RELATED APPLICATIONS

The present application is related to, claims the earliest available effective filing date(s) from (e.g., claims earliest available priority dates for other than provisional patent applications; claims benefits under 35 USC § 119(e) for provisional patent applications), and incorporates by reference in its entirety all subject matter of the following listed application(s) (the “Related Applications”) to the extent such subject matter is not inconsistent herewith; the present application also claims the earliest available effective filing date(s) from, and also incorporates by reference in its entirety all subject matter of any and all parent, grandparent, great-grandparent, etc. applications of the Related Application(s) to the extent such subject matter is not inconsistent herewith:

U.S. provisional patent application 62/987,508 entitled “J-Hook Device for Untwisting Wire”, naming Jeffery Wildwick as inventor, filed 10 Mar. 2020.

### BACKGROUND

### 1. Field of Use

The present invention relates to the general art of tools, and to the particular field of hand tools.

### 2. Description of Prior Art (Background)

The present invention relates to an apparatus for untwisting a wire. More particularly, the invention relates to a wire untwisting apparatus for untwisting assembled electrical cable.

Electrical cables, especially those for heavy duty applications, generally consist as a plurality of wires twisted together to form a single cable. Exemplary of such cables are those known as MC (metaloid), AC (aluminum clad), BX, Romax, as well as other types of twisted and/or stranded cable.

Conventionally, such cable is run in a building or other site where needed, to a box or other junction where the individual wires of the cable are connected, spliced or otherwise joined with other cable or an appropriate electrical connection or apparatus. Of course, in order to connect the individual cables with their respective connections, it is necessary to untwist the individual wires of the cable to free enough length of cable to provide the required connections. Heretofore, the untwisting of the wire has been done manually, a time-intensive and laborious process. For instance, it is not unusual to have so many cables coming into a location that the process of untwisting the various cables can. take a full day or longer by worker(s).

Nothing in the prior art appears to address a particular problem solved by the device of the present invention. For instance, U.S. Pat. No. 3,578,035 to Parker discusses a tool which can be installed on a running length of wire and then adapted to be manipulated in order to twist the wire several times around itself leaving a “bight” or loop. This twister may then bend the running length of wire to extend substantially in an initial direction after which the tool can be reinstalled at a different position along the length of the wire and form a second loop, etc.

In U.S. Pat. No. 4,188,840 to Martschinke, a tool for untwisting the conductors of a twisted conductor cable is discussed. The tool comprises a rod of electrically insulating material having a tapered end and a channel bored into its tapered end, initially along the longitudinal axis of the rod. The channel angles away from the longitudinal axis to emerge at the surface of the rod, and is dimensioned to receive a conductor inserted into the channel at the tapered end of the rod. The tapered end facilitates the initial separation of the conductors and the tool is operated by rotation between thumb and forefinger until the desired length of conductor end segment is reached. Martschinke differs from the present invention in its ability to untwist only a single twisted pair of wires, rather than heavy-duty electrical cable having many wires twisted together.

In U.S. Pat. No. 3,420,280, Allyn describes a wire twisting device on which is mounted an elongated tube having a spirally-grooved spindle therein for effecting rotational movement of the tube and wire twisting device during axial movement of the spindle. The Allyn device, as is apparent, is limited to the twisting of wire and, in addition, can only function to twist a single wire.

In U.S. Pat. No. 450,671, Hoffmann describes a wire twisting tool. The Hoffmann tool consists of a handle having a stem extending therefrom. The stem has a knob at its end. Three strands of wire extend through various parts of the handle (one of which also extends along the length of the stern) and they meet and pass through the knob at the end of the stem. Twisting of the Hoffmann handle thereby twists the three strands of wire together at the “knob” end of the device, thus forming a triple stranded twisted wire.

In Downing, U.S. Pat. No. 2,260,443, a “wire rope nozzle” is disclosed. In this nozzle, a series of wires or rope strands pass through a wheel and into a spindle through which they pass and meet at the far end, where they are twisted into a multi-stranded cable or rope. It is readily apparent that the nozzle of Downing cannot be used as a wire untwisting device, especially since much effort would have to be expended in manually untwisting the wire in order to provide enough length to feed free wire through the spindle and into the wheel. This would effectively defeat the purpose of a wire twisting device since, in effect, much manual wire twisting would have to precede the use of the device.

Similarly, in U.S. Pat. No. 5,853,033 much effort would have to be expended in manually untwisting the wire in order to provide enough length to feed free wire through the disclosed wire guides. This would effectively defeat the purpose of a wire twisting device since, in effect, much manual wire twisting would have to precede the use of the device.

Other prior art solutions may include twisting a piece of smooth wire into the rough shape of a J-hook and jamming the other end into a drill chuck. It will be appreciated that this approach may be inherently dangerous as the shape of the formed J-hook is random and may spin out of the drill chuck injuring the user and/or nearby workers. In addition, the smooth wire is not effective in grabbing the wires to be untwisted.

Nothing in the prior art, therefore, provides a device which can be used effectively and safely for the untwisting of multi-strand wire cables. Without such a device, the installation of such cables remains a laborious enterprise.

What is desired, therefore, is a device which can safely reduce the amount of time it takes to untwist the individual wires of a cable and thereby result in significant savings of time and effort.

### BRIEF SUMMARY

It is an object of the present invention to provide a device for safely untwisting multi-stranded wire cable.

It is a further object of the invention to provide a device which is capable of untwisting wire cable in a manner such that the untwisting of the wire cable can be accomplished with substantial savings of time and effort.

It is also an object of the present invention to provide a wire untwisting device which can be utilized with the assistance of a drill or other mechanical device, wherein the time and labor savings are observed whether the device is used. manually or mechanically.

The invention is directed towards J-hook device for untwisting wire. The J-hook device includes a diamond knurled J-hook section. The diamond J-hook section includes a first straight zone, a second straight zone, and an arc zone disposed between the first straight zone and the second straight zone. The first and second straight zones each comprise a straight length measuring 14.5 units; and the arc zone comprises an outer cord length measuring 28 units, The first straight zone, the second straight zone, and the arc zone are sized for each section to operate cooperatively for untwisting the wire. Also included is a shaft section connected to the knurled J-hook section; and a shank section connected to the shaft section.

These and other objects, which will be apparent to the skilled artisan, can be accomplished with a wire untwisting device which comprises a J-hook having a knurled section and a rotation shaft terminating in a drill bit shank and that rotation of the shall causes rotation of the hook which in turn causes a twisted cable to untwist.

### BRIEF DESCRIPTION OF THE DRAWINGS

The subject matter which is regarded as the invention is particularly pointed out and distinctly claimed in the claims at the conclusion of the specification, The foregoing and other objects, features, and advantages of the invention are apparent from the following detailed description taken in conjunction with the accompanying drawings in which:

FIG. 1 is a top perspective view of a J-Hook Device in accordance with the present invention;

FIG. 2 is a side view thereof;

FIG. 3 is a top view thereof;

FIG. 4 is a rear view thereof:

FIG. 5 is an illustration of a SDS shank in accordance with the present invention; and

FIG. 6 is an illustration showing preferred. relative dimensions.

### DETAILED DESCRIPTION

The following brief definition of terms shall apply throughout the application;

The term “comprising” means including but not limited to, and should be interpreted in the manner it is typically used in the patent context;

The phrases “in one embodiment,” “according to one embodiment,” and the like generally mean that the particular feature, structure, or characteristic following the phrase may be included in at least one embodiment of the present invention, and may be included in more than one embodiment of the present invention (importantly, such phrases do not necessarily refer to the same embodiment);

If the specification describes something as “exemplary” or an “example,” it should be understood that refers to a non-exclusive example; and

If the specification states a component or feature “may,” “can,” “could,” “should,” “preferably,” “possibly,” “typically,” “optionally,” “for example,” or “might” for other such language) be included or have a characteristic, that particular component or feature is not required to be included or to have the characteristic.

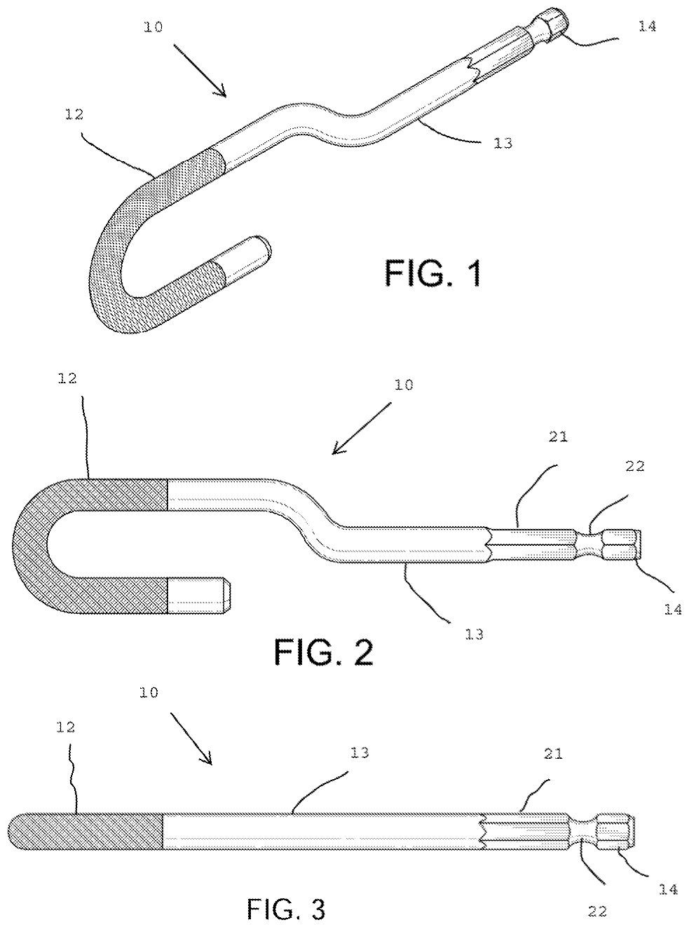

Referring now to FIG. 1-8 of the drawings, there is shown views of the J-Hook Device in accordance with the present invention.

As used herein, the terms “top”, “bottom”, “front”, “rear”, etc. refer to the wire untwisting device of the present invention in the orientation shown in FIG. 1-8, It will be appreciated, however, that the device will assume any of various orientations when in use. It will also be recognized that although the device is described in terms of the untwisting of multi-wire electrical cable, it can also be used to untwist various other multi-strand objects, including. rope. In addition, it is also possible to use the inventive device to twist multi-strand objects such as electrical cable or rope.

In use, the ends of a multi-wire cable, such as one containing from about 12 to about 20 wires, is partially twisted around knurled section 12. It will be appreciated that knurled section 12 provides a gripping surface for holding the ends of the multi-wire cable. The J-hook device 10 is rotated, through rotation of shaft 13, and thereby untwist the length of wire cable. The knurled section 12 may be any suitable knurled pattern, or reticulated pattern, such as, for example, a 60 deg. diamond pattern knurl.

It will be appreciated that hook device 10 may be any suitable metal material such as, for example, stainless steel, low carbon steel, high speed steel (HSS), any suitable steel alloy (e.g., Cobalt). It will also be appreciated that hook device 10 may be any suitable hook device 10 may be any suitable material hook device 10 may be any suitable polymer material such as, for example, non-conducting plastic, carbon fiber reinforced polymer, polystyrene, and/or polycarbonate.

In this manner, untwisting of lengths of multi-wire electrical cable can be accomplished in a significantly reduced time as compared to the currently performed manual untwisting of the wire strands.

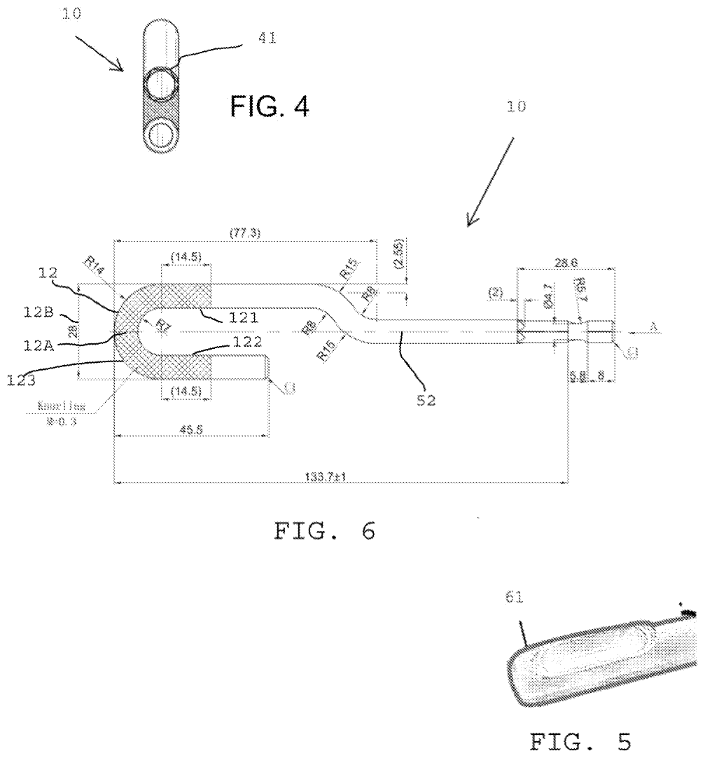

Shaft 13 can also comprise a drill bit shank 14 which is shaped so as to permit J-hook device 10 to securely mate with a drill or other device to facilitate the mechanical rotation of J-hook device 10. It will be appreciated that the drill bit shank 21 may be any suitable shank such as, for example, a 3-flat shank, a reduced shank, a brace shank, a straight shank, a hex shank, a SDS shank (FIG. 5-61), a triangular shank, a Morse taper shank, a square shank, a traded shank, or a tang shank. FIG. 4 shows a rear view 41 of shank 14. It will also be appreciated that shank 21 and shank 14 may be separated by groove 22 to facilitate fitment within an impact drill chuck.

Referring also to FIG. 6 there is shown illustration showing preferred relative dimensions of J-hook device 10. The center line 52 of J-hook device 10 bisects the arc 12A of the knurled section 12. It will he appreciated this feature provides stability and minimizes wobble when the J-hook device 10 is rotated at high speeds.

Still referring to FIG. 6, the knurled section 12 includes three zones, 121, 122, and 123. Zones 121 and 122 are straight knurled zones and each straight zone comprises 14.5 units in length. Zone 123 is an arc zone disposed between zones 121 and 122. The outer cord length of arc zone 123 is 28 units. It will be understood that the relative units of section 12 work cooperatively to efficiently and safely twist and/or untwist wire in accordance with the present invention, The knurled section 12 safely grips a wire bundle to be twisted or untwisted.

It should be understood that the foregoing description is only illustrative of the invention. Thus various alternatives and modifications can be devised by those skilled in the art without departing from the invention Accordingly, the present invention is intended to embrace all such alternatives, modifications and variances that fall within the scope of the appended claims.

What is claimed is:

1. A J-hook device for untwisting wire, the device comprising:
a knurled J-hook section;
a shaft section connected to the knurled J-hook section; and
a shank section connected to the shaft section,

2. The J-hook device as in claim 1 wherein the shank section comprises a drill bit shank.

3. The J-hook device as in claim 2 wherein the drill bit shank comprises a straight shank,

4. The J-hook device as in claim 2 wherein the drill bit shank comprises a hex shank,

5. The J-hook device as in claim 2 wherein the drill hit shank comprises a SDS shank.

6. The J-hook device as in claim 1 wherein the knurled J-hook section comprises a diamond pattern knurl.

7. The J-hook device as in claim 1 wherein the knurled J-hook section comprises;
a first straight zone;
a second straight zone; and
an arc zone disposed between the first straight zone and the second straight zone.

8. The J-hook device as in claim 7 wherein the arc zone comprises an outer cord length measuring 28 units.

9. The J-hook device as in claim 8 wherein the first and second straight zones each comprise a straight length measuring 14.5 units.

10. The J-hook device as in claim 7 further comprising a center line bisecting the arc zone.

11. A J-hook device for untwisting wire, the device comprising:
a knurled J-hook section, wherein the knurled J-hook section comprises
a diamond pattern knurl, and wherein the knurled J-hook section comprises:
a first straight zone;
a second straight zone,
wherein the first and second straight zones each comprise a straight length measuring 14.5 units; and
an arc zone disposed between the first straight zone and the second straight zone, wherein the arc zone comprises an outer cord length measuring 28 units, wherein the first straight zone, the second straight zone, and the arc zone are sized for each section to operate cooperatively for untwisting the wire;
a shaft section connected to the knurled J-hook section; and
a shank section connected to the shaft section.

12. The J-hook device as in claim 11 further comprising a center line bisecting the arc zone.

13. The J-hook device as in claim 11 wherein the drill hit shank comprises a hex shank.

14. The J-hook device as in claim 11 wherein the drill hit shank comprises a SDS shank.
